(19) United States
(12) Patent Application Publication
(10) Pub. No.: US 2010/0039885 A1
(43) Pub. Date: Feb. 18, 2010

(54) Vertical Feed Mixer

(76) Inventor: John Baker, Samia (CA)

Correspondence Address: BRUNET & CO. LTD., 10712 MELROSE DR., KOMOKA, ON, N0L-1R0, CA

(21) Appl. No.: 12/539,700

(22) Filed: Aug. 12, 2009

Related U.S. Application Data
(60) Provisional application No. 61/088,342, filed on Aug. 12, 2008.

(51) Int. Cl. B01F 15/02

(52) U.S. Cl. 366/195

(57) ABSTRACT

The invention is directed to a vertical feed mixer including a hopper for holding a composition to be mixed and having a hopper bottom, a vertically oriented mixing member positioned in the hopper and having a lower edge that is spaced from the hopper bottom, and a scraper movably connected to the mixing member and configured to engage the composition during operation of the mixing member and to be urged downwardly by the composition to the hopper bottom.

### CROSS-REFERENCE TO RELATED APPLICATIONS

This application claims the benefit of U.S. Patent Application 61/088,342, filed Aug. 12, 2008, which is incorporated herein by reference.

### FIELD OF THE INVENTION

The present invention relates to vertical feed mixers and more particularly to a vertical feed mixer having a helical mixing auger with a movable scraper attached to a lower edge thereof.

### BACKGROUND OF THE INVENTION

The mixers comprise a hopper within which is located a vertically oriented helical mixing auger. The mixing auger has a lower leading edge that rides along near the bottom of the hopper and is equipped with a plurality of cutting blades provided at discrete locations along the helical edge. The auger is powered using the power take off (PTO) of a tractor and is connected to the tractor by a suitable drive shaft. In operation, feed materials having varying characteristics (e.g. long hay, corn silage, soybeans, etc.) may be charged into the hopper and mixed together in any desired proportion. Use of the mixer prevents the animals (typically cattle) from feeding discriminately on select portions of their feed ration by creating a substantially homogeneous feed composition. The feed composition may be varied according to time of year, availability of economic feed materials, etc. The mixer therefore provides farmers with an opportunity to feed livestock economically and consistently, leading to optimized animal weight gain. The mixers are equipped with wheels and either a side or front ejection system in order to distribute the mixed feed composition along a feeding trough as the mixer is pulled parallel to the trough. Feed can therefore be easily distributed to a large number of livestock in a feed lot.

Vertical feed mixers can sometimes suffer from the problem of unevenness in the bottom of the hopper. When the auger turns, some material passes under the auger in the uneven portions, which can become squashed into a cake that interferes with proper operation of the mixer and leads to increased mixing horsepower requirements. It would therefore be desirable to reduce the tendency for cake formation across a variety of feed compositions.

### SUMMARY OF THE INVENTION

In one aspect, the invention is directed to a vertical feed mixer including a hopper for holding a composition to be mixed and having a hopper bottom, a vertically oriented mixing member positioned in the hopper and having a lower edge that is spaced from the hopper bottom, and a scraper connected to the mixing member along the lower edge and configured to engage the composition during operation of the mixing member and to be urged downwardly by the composition towards the hopper bottom. The composition to be mixed may be an animal feed composition that is for use in feeding livestock, such as cattle.

In one particular embodiment, the scraper is movably connected to the mixing member, such as by a slidable connection, for example through mounting in slotted apertures, or by a pivotal connection.

### BRIEF DESCRIPTION OF THE DRAWINGS

The present invention will now be described by way of example only with reference to the attached drawings, in which:

FIG. 1 is a cutaway perspective view of a vertical feed mixer in accordance with an embodiment of the present invention;

FIG. 2a is an exploded perspective view of a portion of the vertical feed mixer shown in FIG. 1;

FIG. 2b is an unexploded perspective view illustrating the assembly of the portion of the vertical feed mixer shown in FIG. 2a;

FIG. 2c is an exploded perspective view of a variant of the portion of the vertical feed mixer shown in FIG. 2a;

FIG. 3 is an exploded perspective view of a variant of the portion of the vertical feed mixer shown in FIG. 2a;

FIG. 4a is a perspective view of another variant of the portion of the vertical feed mixer shown in FIG. 2a;

FIG. 4b is a magnified elevation view of the variant shown in FIG. 4a;

FIG. 5a is a perspective view of another variant of the portion of the vertical feed mixer shown in FIG. 2a;

FIG. 5b is a magnified elevation view of the variant shown in FIG. 5a;

FIG. 6a is a perspective view of another variant of the portion of the vertical feed mixer shown in FIG. 2a;

FIG. 6b is a magnified elevation view of the variant shown in FIG. 6a;

FIG. 7a is an exploded perspective view of another variant of the portion of the vertical feed mixer shown in FIG. 2a;

FIG. 7b is an unexploded perspective view of the variant shown in FIG. 7a;

FIG. 8a is a cutaway perspective view of another variant of the portion of the vertical feed mixer shown in FIG. 2a; and,

FIG. 8b is a magnified elevation view of the variant shown in FIG. 8a.

### DETAILED DESCRIPTION OF THE INVENTION

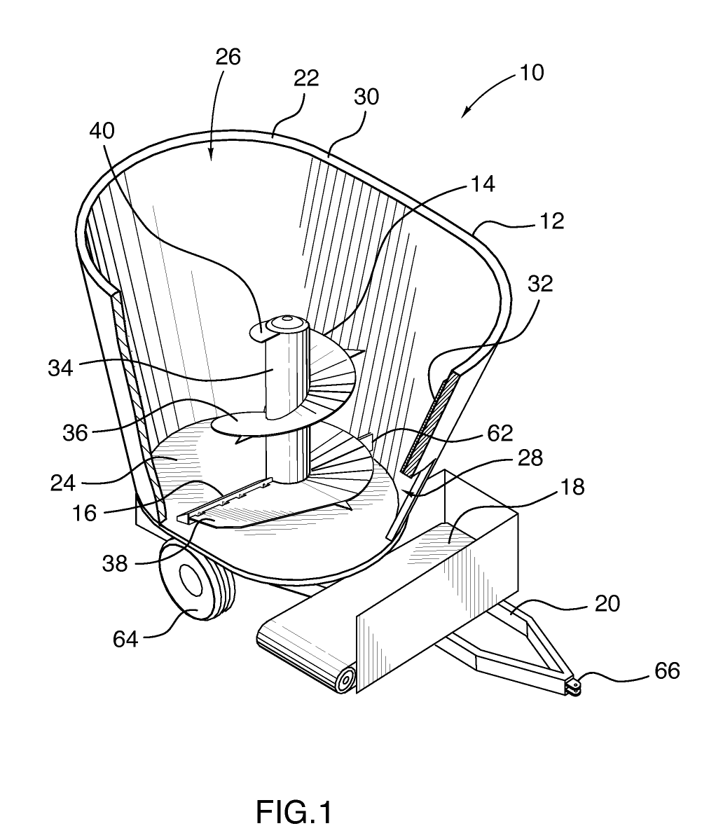

Reference is made to FIG. 1, which shows a vertical feed mixer 10 in accordance with an embodiment of the present invention. The vertical feed mixer 10 may be used for mixing an animal feed composition for use in feeding to animals such as cattle and other livestock. The animal feed composition may have any suitable make up. For example, the animal feed composition may include long hay, corn silage, soybeans, and other component materials.

The vertical feed mixer 10 includes a hopper 12, a mixing member 14, a scraper 16, an outlet conveyor 18, and a support frame 20. The hopper 12 may have any suitable shape. For example, the hopper 12 may be generally capsule-shaped along a horizontal cross-sectional plane. The hopper 12 may taper progressively vertically from a relatively larger cross-sectional area at the top 22, to a relatively smaller cross-sectional area at the bottom 24. The hopper 12 could alternatively have other cross-sectional shapes instead of being capsule-shaped. For example, the hopper 12 could be generally circular in cross-section.

The top 22 of the hopper 12 may be open and may represent an inlet 26 for the introduction of an animal feed composition to be mixed in the hopper 12. The hopper 12 may have an outlet, shown at 28, which is positioned on the hopper side wall, shown at 30, proximate the hopper bottom 24. The outlet 30 may be covered by a cover 32 that is movable to open the outlet 30 to permit the discharge of mixed feed composition from the hopper 12.

The mixing member 14 is positioned in the hopper 12 and extends generally vertically upwards from the hopper bottom 24. The mixing member 14 may include a shaft 34 that extends generally vertically, and a helical member 36 that is mounted on the shaft 34. The helical member 36 may have any suitable configuration. For example, the helical member 36 may taper progressively in the vertical direction having a relatively larger outer diameter at the bottom, shown at 38, to a relatively smaller outer diameter at the top, shown at 40. As a result of the taper of the helical member 36, when the helical member is rotated in the appropriate direction (clockwise in the view shown in FIG. 1), the helical member 36 may drive the animal feed composition generally upwards in the middle of the hopper 12 leaving a space for feed composition from outside the middle region to fill. Thus, rotation of the mixing member 14 generates a circulation of the animal feed composition in the hopper 12.

The shaft 34 may be driven by a motor (not shown) that is positioned below the hopper bottom 24 or alternatively by a power take off (PTO) shaft (not shown) connected to a tractor.

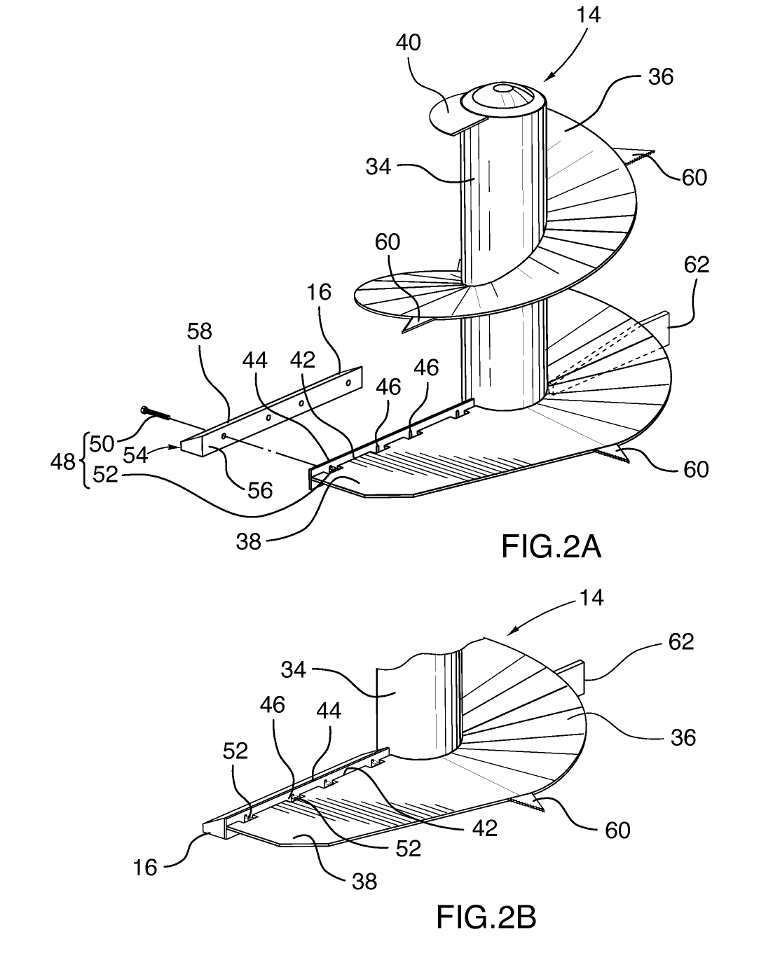

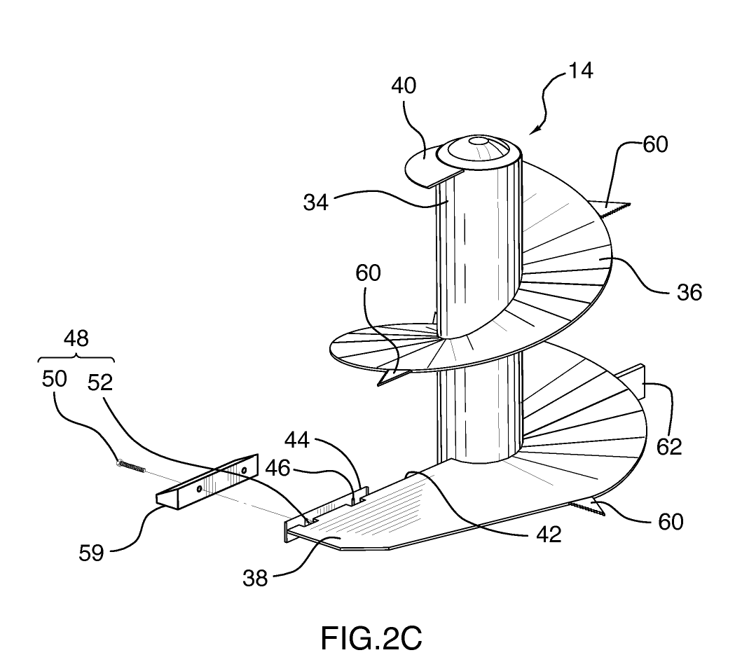

At the bottom of the helical member 36 is a lower edge 42, which is also a leading edge 42 of the helical member 36. At the leading edge 42 may be positioned a vertically oriented mounting plate 44 with a plurality of vertically slotted mounting apertures 46 thereon (seen more clearly in FIG. 2a). A plurality of fasteners 48 mount the scraper 16 to the mounting plate 44 while permitting the scraper 16 to slide vertically in the mounting apertures 46. Not all the fasteners 48 are shown in FIG. 2a.

The hopper 12 and the mixing member 14 may be made from any suitable material, for example a metal, such as steel.

Each fastener 48 may be made up of a bolt 50 and a nut 52. The nuts 52 are positioned on the bolts 50 to permit sufficient play between the scraper 16 and the mounting plate 44 so as to permit the scraper 16 to slide up and down as necessary during use. Elongation of the bolts 50 also allows the scraper 16 to move inwardly and outwardly relative to the mounting plate 44. The combination of these two types of movement results in limited arcuate movement of the scraper 16 relative to the mounting plate 44.

In the embodiment shown in FIGS. 2a and 2b, four fasteners 48 are shown for mounting the scraper 16 to the mixing member 14. However, it is optionally possible to use fewer or more fasteners 48 as suitable. It will be understood that other types of fastener could be used instead of bolts 50 and nuts 52. Preferably the scraper 16 is removably connected to the mixing member 14 for reasons described further below.

The scraper 16 is configured to cooperate with the animal feed composition in the hopper such that when the mixing member 14 is turned, the animal feed composition in the hopper pushes down on the scraper 16 urging it towards the hopper bottom 24. For example, the scraper 16 may have a leading edge 54 and a trailing edge 56 and may have an upper surface 58 that is angled upwardly relative to horizontal from the leading edge 54 to the trailing edge 56. The slotted apertures 46 are positioned to permit the scraper 16 to slide sufficiently far down to contact the hopper bottom 24.

As the mixing member 14 is rotated, the scraper 16 engages the animal feed composition and is urged downwardly thereby, where it engages the hopper bottom 24. Due to unevenness, (ie. imperfect flatness) in the hopper bottom 24, the scraper 16 will move upwardly and downwardly as it sweeps along the hopper bottom 24, maintaining contact therewith under the force of engagement with the animal feed composition during rotation of the mixing member 14. By providing a floating scraper as shown in FIGS. 1, 2a and 2b, vertical feed mixer 10 is thus configured to reduce the amount of compressed animal feed composition cake that builds up on the hopper bottom 24, relative to a vertical feed mixer 14 that has no scraper 16 or a scraper 16 that is fixed in position.

The angle of the upper surface 58 of the scraper 16 controls the force with which the animal feed composition urges the scraper 16 downwards. Although any suitable angle may be used, preferred angles are in the range of about 10 to about 70 degrees, more preferably about 15 to about 65 degrees, yet more preferably about 20 to about 60 degrees, even more preferably about 25 to about 55 degrees, still more preferably about 30 to about 50 degrees relative to horizontal, most preferably about 35 to about 45 degrees. It may be desirable to permit the angle of the upper surface 58 to be selected based on the particular animal feed composition to be mixed. To permit the upper surface angle to be selected, a plurality of scrapers 16 may be provided that are interchangeably connectable to the mounting plate 44, each with a different angle on their respective upper surface 58 so that the appropriate one may be selected and installed on the mixing member 14 for use with a particular animal feed composition.

Referring to FIG. 2c, although the scraper 16 shown in FIGS. 2a and 2b spans substantially the entire leading edge 42, it is also possible to provide a scraper 59 that spans only a portion of the leading edge 42. For example, the scraper 59 may have a length greater than or equal to 25% of the length of the leading edge 42, greater than or equal to 50% of the length of the leading edge 42, or greater than or equal to 75% of the length of the leading edge 42. It is desirable that the scraper 59 be positioned towards the outer end of the leading edge 42, proximal the exterior of the hopper 12, as this is where feed is most likely to accumulate and/or un-evenness in the floor of the hopper 12 is most likely to occur. A fixed (i.e. non-movable) beveled edge may be provided to the portion of the leading edge 42 not equipped with the scraper 16, proximal the shaft 34, both in an effort to prevent feed from being diverted under the leading edge 42 and to stiffen it. This helps prevent undesirable upward tilting of the scraper 59 due to flexibility in the leading edge 42.

It is desirable that the presence of the scraper 16 on the mixing member 14 reduces the horsepower requirement on the motor driving the mixing member 14 relative to the absence of the scraper under conditions that are otherwise similar or substantially identical. A reduction in horsepower may also be observed relative to fixed scrapers. Without being limited by theory, this reduction in mixing power is contemplated to be a result of the reduced build up of compressed animal feed composition cake on the hopper bottom 24 (FIG. 1). Preferred angles for the upper surface 58 of the scraper 16 result in a reduction of mixing horsepower of at least about 5%, more preferably at least about 10%, yet more preferably at least about 15% relative to the absence of the scraper 16.

The scraper 16 may be made from any suitable material, for example, metal or plastic. In one embodiment, the scraper is made from a material that is relatively softer than the material of the hopper bottom 24 to ensure that the scraper 16, and not the hopper bottom 24, is the item that requires eventual replacement after prolonged use of the vertical feed mixer 10. The scraper 16 may for example, be made from ultra-high molecular weight (UHMW) polyethylene. By making the scraper 16 sufficiently soft, the underside of the scraper 16 may configure itself over time to more closely engage the irregular surface that makes up the hopper bottom 24, which further reduces the amount of build-up of compressed animal feed composition cake on the hopper bottom 24. Whether made from plastic or metal, the scraper should be made rigid enough to prevent feed cake from lifting the scraper off of the bottom of the hopper, as this allows accumulated feed cake to pass under the scraper and also can lead to an increase in required mixing horsepower. The scraper should also be durable enough to prevent excessive wear during operation and, for this reason, may be made of a metal material.

The mixing member 14 may have additional features thereon. For example, one or more cutting elements, shown at 60 may be provided on the outer edge of the mixing member 14. The cutting elements 60 serve to cut some of the pieces of the animal feed composition to reduce the average size of the pieces.

Another optional feature is to provide a kicker 62 on the mixing member 14. The kicker 62 may extend radially along the underside of the bottommost flight of the helical member 36. The kicker 62 may be positioned generally opposite to the scraper 16. Optionally (not shown), a scraper similar to the scraper 16 may be mounted on the kicker 62, preferably through vertically slotted apertures.

The mixed animal feed composition that is discharged through the outlet 28 is conveyed by the outlet conveyor 18 to a suitable location, such as to a feed bin (not shown) for consumption by animals such as cattle. The outlet conveyor 18 may be any suitable type of conveyor such as, for example, a belt conveyor. The outlet conveyor 18 may be driven by a motor (not shown) or powered through the PTO shaft (not shown) through a suitable belt or chain drive system.

Referring to FIG. 1, the support frame 20 may have any suitable configuration. For example, the support frame 20 may include wheels 64 and a mount 66 for connecting to a tractor (not shown), so that the support frame 20 can be pulled as a trailer behind the tractor. An electrical or hydraulic power connector may be provided proximate the mount 66 for connection to the tractor in order to power the motor (not shown) for the mixing member 14 or the motor (not shown) for the outlet conveyor 18.

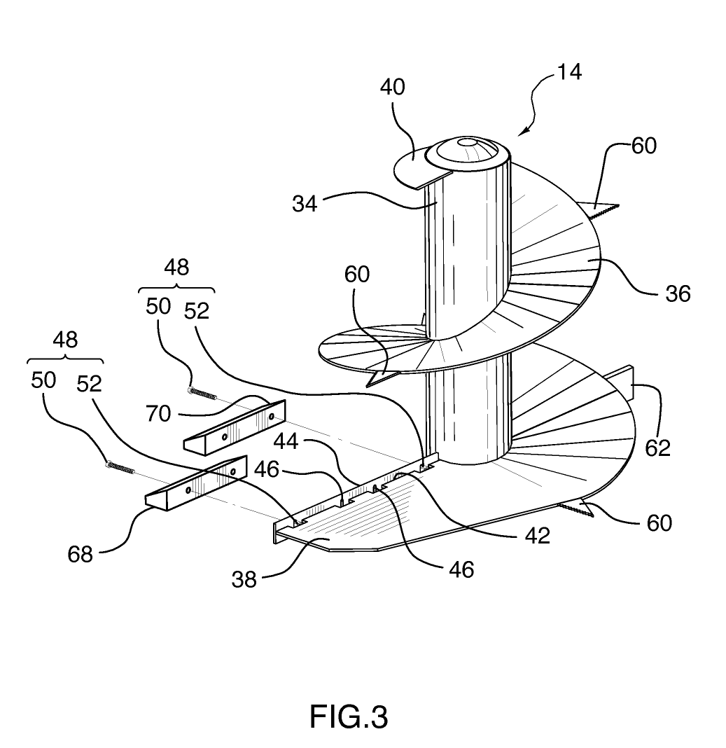

Reference is made to FIG. 3, which shows the mixing member 14 with a first scraper 68 and a second scraper 70 thereon that may be used instead of the single scraper 16 shown in FIG. 1. Each of the first and second scrapers 68 and 70 is supported by two fasteners 48, each fastener 48 comprising a bolt 50 and a nut 52 that passes through a slotted aperture 46 on the mixing member 14. As a result, the scrapers 68 and 70 are positioned to engage first and second portions of the hopper bottom respectively. Providing two smaller scrapers 68 and 70 instead of one scraper 16 (FIG. 1) permits each scraper 68 and 70 to follow the particular surface topography associated with its own portion of the hopper bottom 24. For example, if a raised portion were present in the first portion of the hopper bottom 24, it would cause the first scraper 68 to rise upwards slightly to pass over it. If the raised portion did not extend into the second hopper bottom portion, the second scraper 70 would remain engaged with the bottom 24 while the first scraper 68 rises to accommodate the protuberance.

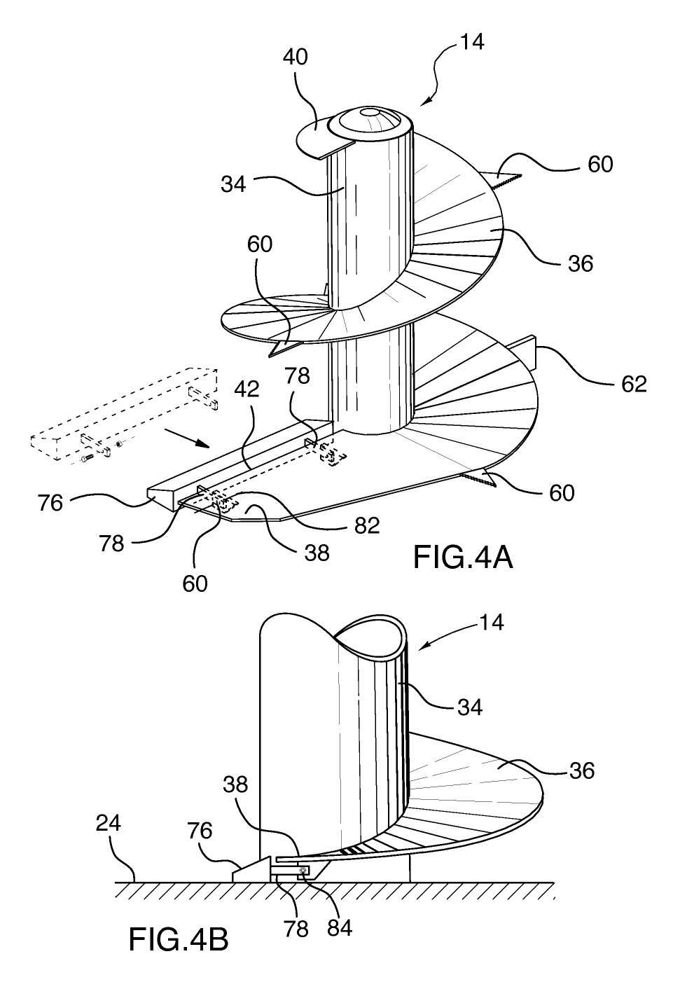

Reference is made to FIGS. 4a and 4b, which show the mixing member 14 with a scraper 76 connected thereto. The scraper 76 may generally be similar to the scraper 16 (FIG. 1), however the scraper 76 is pivotally connected to the mixing member 14. The scraper 76 may include two arms 78, each of which pivotally connect to an associated mounting ear 80 about a pivot axis 82 on the underside of the helical member 36 using a fastener 84. The pivot axis is substantially parallel to the lower edge (leading edge 42) of the mixing member 14. The fastener 84 may include a bolt and a nut so as to be easily removable when it is desired to replace the scraper 76 with another scraper due to wear or due to the mixing of a different animal feed composition. Pivotally connecting the scraper 76 to the mixing member 14 permits vertical movement of the scraper 76 to accommodate unevenness in the hopper bottom 24, while having a simpler mounting plate construction than the embodiment comprising vertically slotted apertures as shown in FIGS. 1, 2a and 2b.

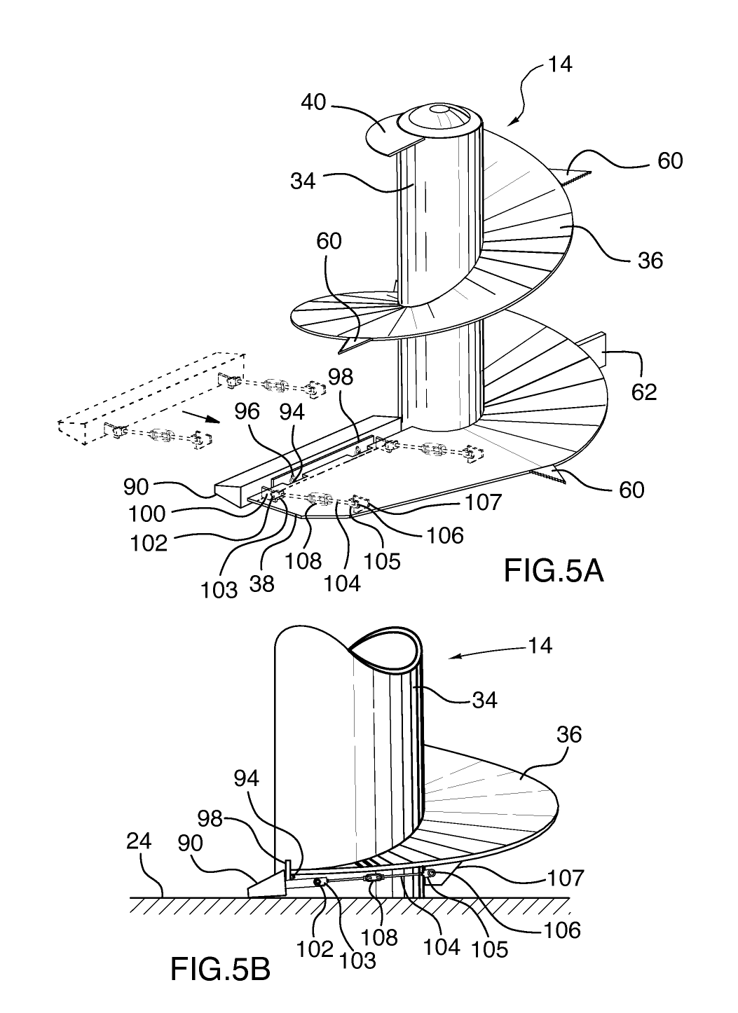

Reference is made to FIGS. 5a and 5b, which show the mixing member 14 with a scraper 90 connected thereto. The scraper 90 may be similar to the scraper 16 (FIG. 1) and may be slidably connected to the helical member 36 by means of fasteners 94 that pass through vertical slotted apertures 96 on a mounting plate 98 at the leading edge of the helical member 36. The scraper 90 however also includes a mounting arm 100 where it is pin jointed at 102 with a first end 103 of a variable length member comprising a turnbuckle 104. The second end shown at 105 of the turnbuckle 104 is pin jointed at 106 to a mounting ear 107 on the underside of the helical member 36. Prior to operation of the mixer 10 (FIG. 1), a user may rotate the turnbuckle body, shown at 108, by a selected amount, which sets the length of the turnbuckle 104. There is sufficient play in the connection of the scraper 90 and the slotted apertures 96 using the fasteners 94 that the scraper 90 is movable vertically in the slotted apertures 96, changing in orientation and pivoting as necessary at the pin joint 102 with the first end 103 of the turnbuckle 104 to accommodate vertical movement. The turnbuckle 104 is an example of a scraper pre-loading member that is adjustable to permit adjustment of the force exerted on the scraper at rest. Adjusting the turnbuckle 104 provides a selected degree of resistance to the scraper 90 to upward movement from animal feed composition passing thereunder during use.

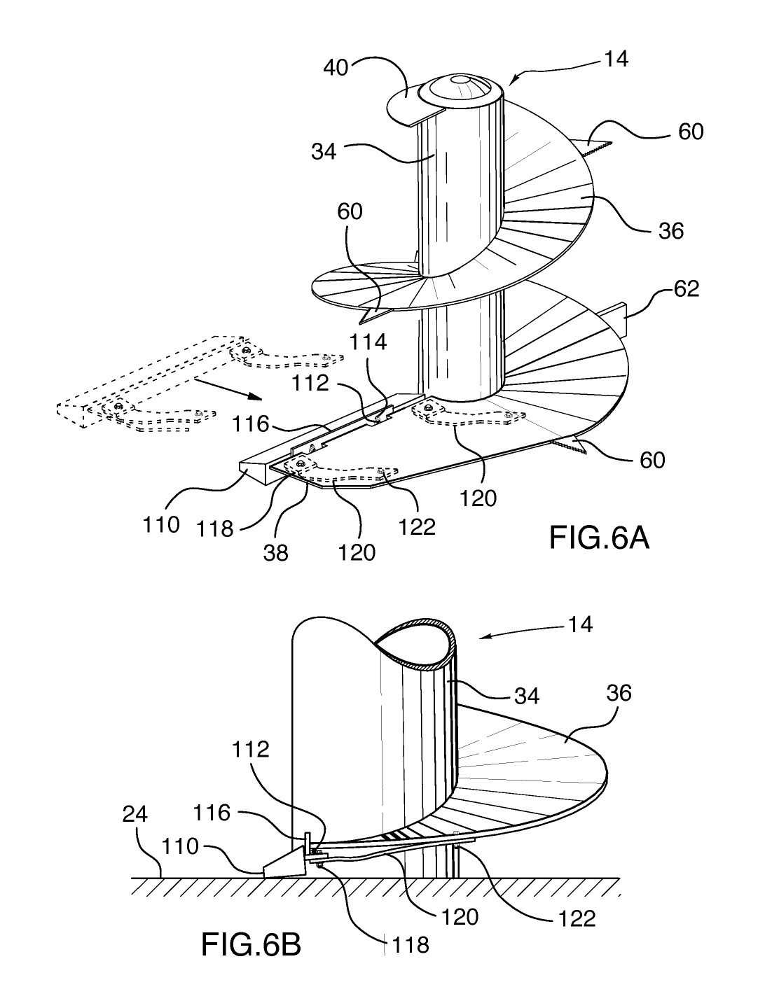

Reference is made to FIGS. 6a and 6b, which show the mixing member 14 with a scraper 110 connected thereto. The scraper 110 may be similar to the scraper 16 (FIG. 1) and may be slidably connected to the helical member 36 by means of fasteners 112 that pass through vertical slotted apertures 114 on a mounting plate 116 at the leading edge of the helical member 36. The scraper 110 is also connected to first ends 118 of a pair of resilient members, for example elastic members 120. The second end shown at 122 of the elastic member 120 is connected to the underside of the helical member 36. During use, vertical movement of the scraper 110 in the slotted apertures 114 is accommodated by stretching/contraction of the elastic member 120 as necessary. By having some degree of pre-tension in the elastic member 120, the elastic member 120 provides some resistance to the scraper 90 to upward movement from animal feed composition passing thereunder during use. The elastic member 120 is an example of a pre-loading member that exerts a downward force on the scraper 110 and provides an alternative to the pre-loading member shown in FIGS. 5a and 5b.

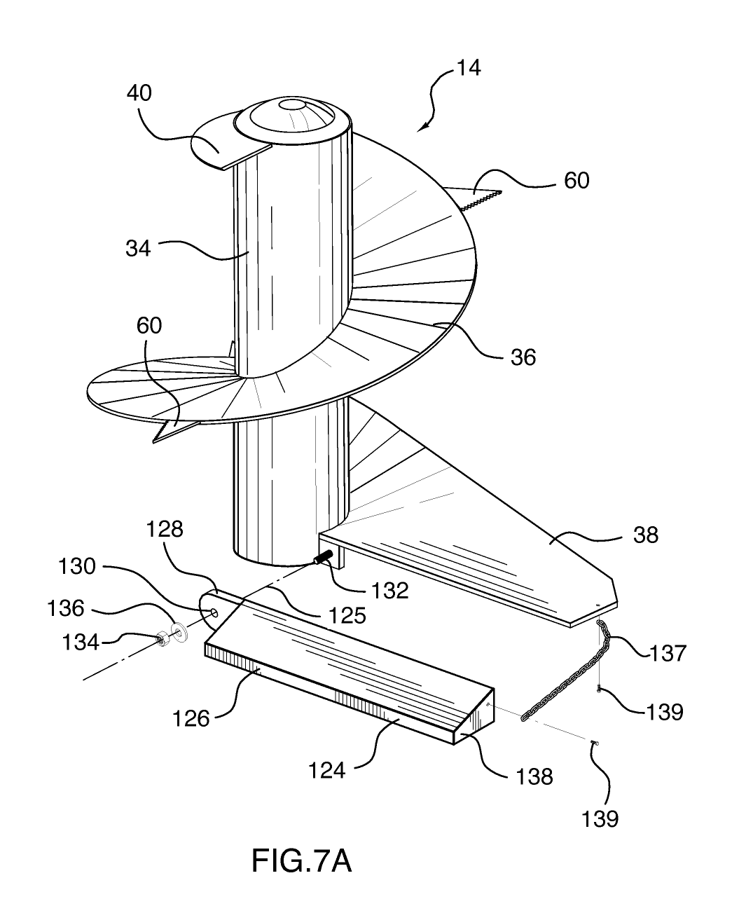

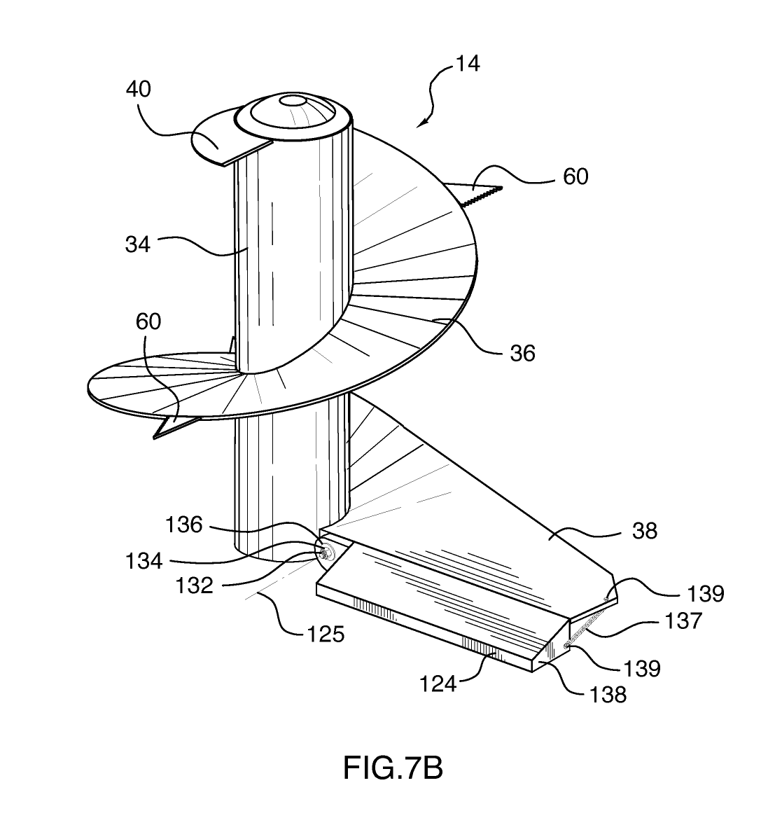

Reference is made to FIGS. 7a and 7b, which show the mixing member 14 with a scraper 124 connected thereto. The scraper 124 may be similar to the scraper 16 (FIG. 1) but instead of sliding up and down vertically, the scraper 124 is pivotable about a generally horizontal pivot axis 125 that is generally perpendicular to the lower edge of the mixing member 14. The scraper 124 includes a scraper body 126 and a mounting ear 128 that extends from the scraper body 126 and that has a mounting aperture 130 therethrough that is spaced radially inwardly from the scraper body 126. A threaded rod 132 on the mixing member 14 defines the pivot axis 125 and passes through the mounting aperture 130. A nut and washer 134 and 136 may secure the scraper 124 to the threaded rod 132. A connecting member 137 that is preferably flexible, such as a chain, is optionally mounted between the radially outer end, shown at 138, of the scraper body 126 and the helical member 36. The connecting member may be connected to the scraper body 126 and to the helical member 36 by any suitable means, such as by threaded fasteners 139 and is provided to constrain the pivoting movement of the scraper body 126. During use, the scraper 124 may pivot about the pivot axis 125 to accommodate unevenness in the hopper bottom 24. It will be understood that the threaded rod 132 could alternatively extend from the mounting ear 128 and that the aperture 130 could be positioned on the mixing member 14. It will further be understood that any other suitable means of pivotally mounting the scraper 124 to the mixing member 14 may be used.

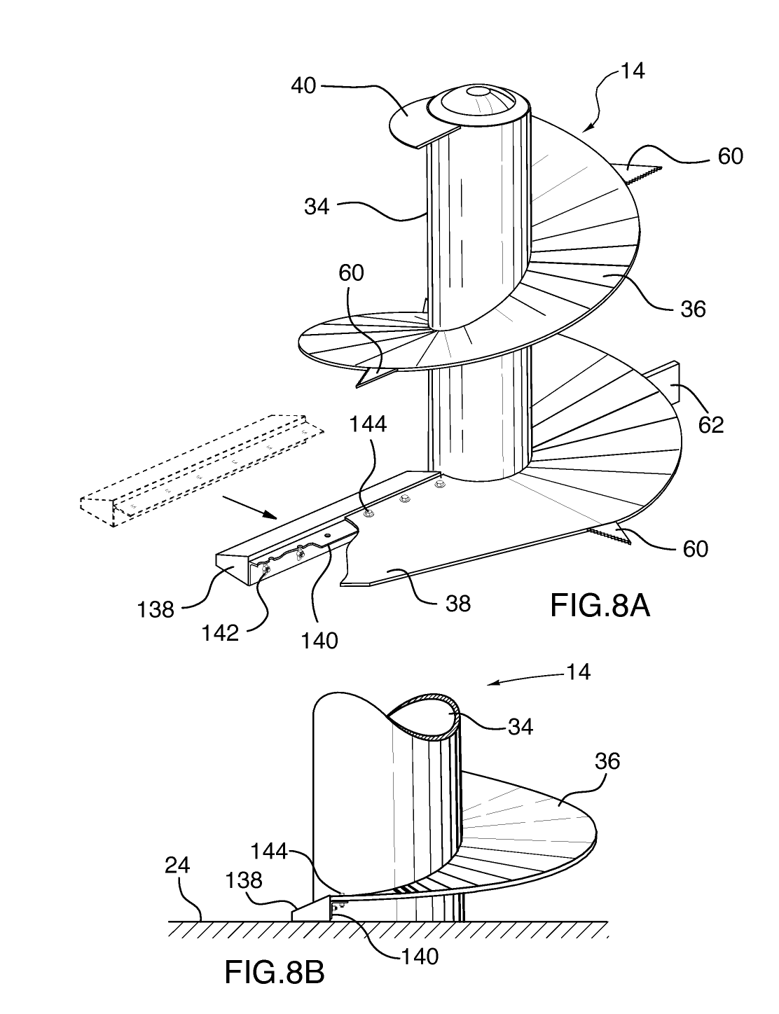

Reference is made to FIGS. 8a and 8b, which show the mixing member 14 with a scraper 138 connected thereto. The scraper 138 may be the same as the scraper 16 (FIG. 1). The scraper 138 mounts to a mounting plate 140 with vertically slotted apertures 142 thereon. The mounting plate 140 may be similar to the mounting plate 44 except that the mounting plate 140 may be joined to the helical member 36 by means of threaded fasteners 144.

### EXAMPLE

Several different scraper designs were built and tested on the leading edge of a prototype vertical feed mixer. The prototype mixer had a single central helical auger with a leading edge length of 24″. The mixer was driven by a PTO attachment to a tractor. Coupled in-line with the PTO shaft between the tractor and the prototype vertical feed mixer was a digital torque and power transducer connected to a laptop computer. The computer was used to electronically log the horsepower required to operate the prototype feed mixer with a given feed composition and mixing speed.

Using this test apparatus, a variety of leading edge configurations were tested. Qualitative visual analysis was performed for the accumulation of feed on the hopper bottom and the degree of feed mixing. Quantitative analysis of the horsepower required to operate the feed mixer was conducted using the data obtained with the computer. The parameters for selected examples of movable leading edges tested are provided in Table 1 and the results of the mixing experiments are provided in Table 2.

TABLE 1
Leading Edge Parameters

| Experiment | Scraper Angle | Scraper Length | Material |
|---|---|---|---|
| Control | N/A | N/A | N/A |
| 1 | 30° | 24″ | UHMW Plastic |
| 2 | 35° | 14″ | Steel |

TABLE 2
Mixing Experiments

| | Change in Power | |
|---|---|---|
| | (% relative to | |
| Experiment | control) | Observations |
| Control | 0 | Accumulation on bottom of |
| | | hopper. Adequate mixing. |
| 1 | +5% | Less accumulation than |
| | | control. Scraper lifting due to |
| | | insufficient angle, causing |
| | | increase in required mixing |
| | | power. Good mixing. |
| 2 | −5% | Less accumulation than |
| | | control, but more than full |
| | | length scraper. No scraper |
| | | lifting due to increased angle |
| | | and hence lower power. |
| | | Good mixing. |

Referring to Tables 1 and 2, the Control refers to a standard auger with no floating scraper on the leading edge. The Change in Power is as a percentage relative to the Control value and represents an approximate average of several experimental values taken with the configuration indicated. Averaging in this manner helped to de-emphasize the effects of changes in variables such as the feed composition, hopper filing height, etc.

It can be seen that modifying the leading edge to include the moveable scraper of Experiment 1 actually increased the required mixing horsepower. It is speculated that this was due to upward tilting of the scraper due to flexibility (i.e. insufficient rigidity) in the leading edge itself. Switching to a shorter scraper on the outer part of the leading edge allowed the remaining edge portion proximal the center of the helical auger to be beveled and consequently stiffened, making it less likely to permit tilting and bending of the scraper during operation. This resulted in a decrease in the power required to achieve mixing (as compared with the control) under otherwise identical conditions. Use of a rigid metal scraper may have helped somewhat, however due to the movable connection between the leading edge and the scraper, the change of materials is not presumed likely to have made a significant difference to leading edge stiffness. The change of materials did, however, increase durability of the scraper as compared with the UHMW version. Both scrapers seemed to ameliorate the build-up of compressed feed cake on the bottom of the hopper and visually appeared to improve the mixing characteristics of the feed mixer.

While the above description constitutes a plurality of embodiments of the present invention, it will be appreciated that the present invention is susceptible to further modification and change without departing from the fair meaning of the accompanying claims.

1. A vertical feed mixer, comprising:
a hopper for holding a composition to be mixed, the hopper having a hopper bottom;
a vertically oriented mixing member positioned in the hopper and having a lower edge that is spaced from the hopper bottom; and
a scraper movably connected to the mixing member along the lower edge and configured to engage the composition during operation of the mixing member and to be urged downwardly by the composition towards the hopper bottom.

2. The vertical feed mixer as claimed in claim 1, wherein the scraper is a first scraper and is configured to engage a first portion of the hopper bottom, and wherein the vertical feed mixer further comprises a second scraper movably connected to the mixing member and configured to engage the composition during operation of the mixing member and to be urged downwardly by the composition towards the hopper bottom, and wherein the second scraper is positioned to engage a second portion of the hopper bottom.

3. The vertical feed mixer as claimed in claim 1, wherein the scraper is slidably connected to the mixing member.

4. The vertical feed mixer as claimed in claim 3, wherein the leading edge further comprises a mounting plate having a plurality of slotted apertures and wherein the scraper is connected to the mixing member by means of fasteners protruding through the apertures.

5. The vertical feed mixer as claimed in claim 4, wherein the scraper is able to move arcuately relative to the mounting plate.

6. The vertical feed mixer as claimed in claim 1, wherein the scraper is pivotally connected to the mixing member.

7. The vertical feed mixer as claimed in claim 1, wherein the scraper has a leading edge and a trailing edge and an upper face that extends generally upwardly from the leading edge to the trailing edge at an angle to horizontal.

8. The vertical feed mixer as claimed in claim 7, wherein the angle is from about 10 to about 70 degrees.

9. The vertical feed mixer as claimed in claim 7, wherein the angle is from about 25 to about 55 degrees.

10. The vertical feed mixer as claimed in claim 1, wherein the scraper is made from a polymeric material and the hopper is made from a metal.

11. The vertical feed mixer as claimed in claim 6, wherein the scraper is pivotally connected to the mixing member for pivoting movement about a scraper pivot axis that is perpendicular to the lower edge.

12. The vertical feed mixer as claimed in claim 6, wherein the scraper pivots about a pivot axis that is parallel to the lower edge.

13. The vertical feed mixer as claimed in claim 1, further comprising a scraper pre-loading member that connects between the scraper and the mixing member and exerts a force on the scraper at rest.

14. The vertical feed mixer as claimed in claim 13, wherein the scraper pre-loading member includes a variable length member.

15. The vertical feed mixer as claimed in claim 14, wherein the scraper pre-loading member is adjustable to permit adjustment of the force exerted on the scraper at rest.

16. The vertical feed mixer as claimed in claim 14, wherein the scraper pre-loading member includes a resilient member.

17. The vertical feed mixer as claimed in claim 1, wherein the scraper is removably mounted to the mixing member.

18. The vertical feed mixer as claimed in claim 1, wherein the scraper is a first scraper and wherein the first scraper has an upper surface that extends from a leading edge to a trailing edge at a first angle, and wherein the vertical feed mixer further comprises a second scraper having an upper surface that extends from a leading edge to a trailing edge at a second angle, wherein the first and second scrapers are interchangeably mounted to the mixing member.

19. The vertical feed mixer as claimed in claim 1, wherein presence of the scraper reduces required mixing power as compared with absence of the scraper under conditions that are otherwise similar.

20. The vertical feed mixer as claimed in claim 1, wherein the scraper is in contact with at least a portion of the bottom of the hopper during operation of the mixing member.
